(19) United States
(12) Patent Application Publication
(10) Pub. No.: US 2022/0279853 A1
(43) Pub. Date: Sep. 8, 2022

(54) ATOMIZING ASSEMBLY OF ELECTRONIC CIGARETTE AND PREPARATION METHOD THEREOF

(71) Applicant: O-NET AUTOMATION TECHNOLOGY (SHENZHEN) LIMITED, Shenzhen, Guangdong (CN)

(72) Inventors: Huihua Huang, Shenzhen, Guangdong (CN); Meiling Guo, Shenzhen, Guangdong (CN); Bo Zhou, Shenzhen, Guangdong (CN)

(21) Appl. No.: 17/636,025

(22) PCT Filed: Sep. 24, 2019
(86) PCT No.: PCT/CN2019/107562

§ 371 Date: Feb. 16, 2022

(51) Int. Cl. A24F 40/46; A24F 40/70

(52) U.S. Cl. CPC A24F 40/46; A24F 40/70

(57) ABSTRACT

The disclosure discloses an atomizing assembly of an electronic cigarette and a preparation method thereof. The preparation method includes steps of: S1, providing a substrate; S2, plating a plurality of heating layers on a plurality of to-be-plated positions by vacuum plating according to the plurality of selected to-be-plated positions on a surface of the substrate; S3, cutting the substrate into a plurality of separated base bodies according to positions of the plurality of heating layers, each base body and the heating layer thereon form one atomizing assembly. The heating layers are attached to the substrate by vacuum plating, thus the plating is uniform and compact, high in size precision, strong in adhesive force and difficult to fall off. The substrate with the heating layers is cut into a plurality of separated atomizing assemblies, thus the production efficiency is higher, the product consistency is better and the product is more stable.

### TECHNICAL FIELD

The present disclosure relates to the field of electronic cigarettes, and more particularly to an atomizing assembly of an electronic cigarette and a preparation method thereof.

### DESCRIPTION OF RELATED ART

Currently, atomizing assemblies of electronic cigarettes are mainly prepared by the following three processes:

1. A wire winding process by an automatic wire winding machine, which is usually used to prepare the atomizing assembly with a structure of a spring coil, a winding cotton or a winding glass fiber, and can be subdivided into a simple winding process, a butt welding process and a riveting process. However, the product prepared by the wire winding process has a poor consistency of resistance, pitch and heating wire diameter, and the atomizing assemblies are formed individually, resulting in low production efficiency.

2. A co-firing process, which is generally used to prepare the atomizing assembly with a low-temperature ceramic structure. The co-firing process specifically includes the following operation steps: placing a heating element in a ceramic mold; preparing a ceramic green body; and sintering the ceramic green body at a low temperature of 500-800 degrees Celsius after dewaxing to form a finished product. The co-firing process requires the heating element to have a certain supporting force, and therefore cannot be used to prepare the atomizing assembly with high resistance, and meanwhile, has the problems that ceramic powder is easy to fall off, the heating element is easy to peel off, the consistency of the heating element is poor. Besides, the atomizing assemblies are molded singly, resulting in low production efficiency.

3. A thick film printing process, which is usually used to prepare the atomizing assembly with a high-temperature ceramic structure. Compared with the co-firing process, the printing process has advantages that the ceramic powder is not easy to fall off, the mass production process is simpler, and the production efficiency is higher. The printing process specifically includes the following steps: preparing a high-temperature porous ceramic; grinding the high-temperature porous ceramic into a required size, and then cleaning and drying it; printing a slurry and drying it; sintering; and cutting into the required atomizing assembly. However, since the surface of the ceramic is uneven, the adhesion force of the slurry is poor, and the heating element formed after sintering is easy to fall off. Meanwhile, the thickness of the resistance film obtained by the printing process is uneven since the ceramic absorbs the slurry, resulting in poor consistency of the resistance value of the product and easy local burning out. In addition, because the slurry is not a pure metal material, and the sintered slurry contains a certain amount of metal oxides, glass powder, etc., so the resistance drift and other phenomena will occur when the product is heated during use.

### SUMMARY OF THE DISCLOSURE

The technical problem to be solved by the present disclosure is to provide a preparation method of an atomizing assembly of an electronic cigarette with a high production efficiency, an excellent product consistency and an excellent stability, and the atomizing assembly of the electronic cigarette prepared by the method, in view of the above defects in the prior art.

The technical solution adopted by the present disclosure to solve the technical problem is to provide a preparation method of an atomizing assembly of an electronic cigarette, including steps of:

S1, providing a substrate;

S2, plating a plurality of heating layers on a plurality of to-be-plated positions by vacuum plating according to the plurality of selected to-be-plated positions on a surface of the substrate; and

S3, cutting the substrate into a plurality of separated base bodies according to positions of the plurality of heating layers, wherein each base body and the heating layer thereon form one atomizing assembly.

Preferably, the plurality of to-be-plated positions are spaced arranged on the surface of the substrate; and

before the step S2, the preparation method further includes:

step S1.1, shielding the surface of the substrate and exposing the plurality of to-be-plated positions according to the plurality of selected to-be-plated positions which are spaced arranged on the surface of the substrate; and

before the step S3, the preparation method further includes:

step S2.1, removing a shield used for shielding on the surface of the substrate.

Preferably, in the step S1, the substrate is a liquid conducting substrate, a pore diameter of the substrate is 5 μm to 200 μm, and a porosity of the substrate is 20% to 80%.

Preferably, before the step S2, the preparation method further includes:

step S1.2, plating adhesive layers on the to-be-plated positions by vacuum plating; and

in the step S2, the heating layers are plated on the adhesive layers.

Preferably, a material of each adhesive layer includes one or more of Si, TiN, ZrN, TiO, Cr₂O₃, Al₂O₃, Fe₃C, Mn₂O₄, TiO₂, SiO₂; and a material of each heating layer includes one or more of Ti, Ag, Cr, Ni, Fe, Al and an alloy material thereof, carbon and graphite.

Preferably, in the step S1, the substrate is a thin sheet substrate with a smooth and flat surface.

Preferably, each heating layer includes two spaced electrode contacts and a heating track connected between the two electrode contacts.

Preferably, in the step S1, the substrate is a thin sheet substrate with a smooth and flat surface; and

the step S1 further includes: processing at least two opposite sides of the substrate according to a peripheral shape of each base body in the atomizing assembly; and

the plurality of to-be-plated positions include two opposite surfaces of the substrate and side surfaces of two opposite sides of the substrate.

Preferably, a material of each heating layer includes one or more of Ti, Ag, Cr, Ni, Fe, Al and an alloy material thereof, carbon and graphite.

The disclosure further provides an atomizing assembly of an electronic cigarette, which is prepared by the preparation method of any one of the above.

According to the preparation method of the atomizing assembly of the electronic cigarette, the heating layers are attached to the substrate by vacuum plating, thus the plating is uniform and compact, high in size precision, strong in adhesive force and difficult to fall off; and then the substrate with the heating layers is cut into a plurality of separated atomizing assemblies, so that the production efficiency is higher, and the product consistency is better and the product is more stable.

### BRIEF DESCRIPTION OF THE DRAWINGS

The disclosure will now be further described with reference to the accompanying drawings and examples, in which:

FIG. 1 is a process structure diagram of a preparation method of an atomizing assembly of an electronic cigarette in a first embodiment of the present disclosure;

FIG. 2 is a process structure diagram of a preparation method of an atomizing assembly of an electronic cigarette in a second embodiment of the present disclosure; and

FIG. 3 is a process structure diagram of a preparation method of an atomizing assembly of an electronic cigarette in a third embodiment of the present disclosure.

### DESCRIPTION OF THE EMBODIMENTS

For better understanding of the technical features, purposes, and efficacy of the present disclosure, embodiments of the present disclosure will be described in detail with reference to the drawings.

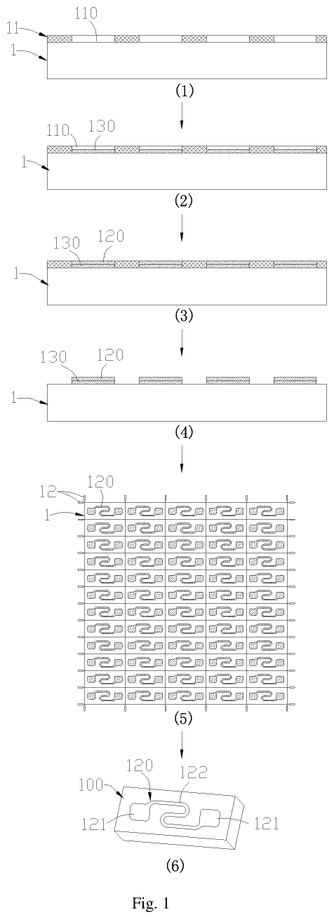

As shown in FIG. 1, a preparation method of an atomizing assembly of an electronic cigarette in a first embodiment of the present disclosure includes the following steps:

Step S1: providing a substrate 1.

In this embodiment, the substrate 1 is a liquid conducting substrate having micropores for liquid conducting. Preferably, a pore diameter of the liquid conducting substrate is 5 μm to 200 μm, and a porosity of the liquid conducting substrate is 20% to 80%.

Alternatively, the liquid conducting substrate may be a porous ceramic or a metal foam.

A corresponding number of to-be-plated positions 110 is selected on an surface of the substrate 1 according to the size of the substrate 1 and the size and number of the individual atomizing assembly to be prepared. A plurality of to-be-plated positions 110 are selected on the surface of the substrate 1 according to a surface of the substrate on which the heating layers in the atomizing assembly are located. In this embodiment, the plurality of to-be-plated positions 110 are spaced arranged, and may be arranged in a matrix (multiple rows and multiple columns).

Step S1.1: shielding the surface of the substrate 1 and exposing the to-be-plated positions 110, according to the selected multiple to-be-plated positions 110 spaced arranged on the surface of the substrate 1.

As shown in FIG. 1 (1), a tool or a film 11 can be selected for shielding, and the tool or the film 11 has a plurality of hollow portions; the tool or the film 11 is covered on the surface of the substrate 1 to shield portions of the surface of the substrate 1 other than where the plurality of to-be-plated positions 110 are located, and the hollow portions are configured to expose the to-be-plated positions 110. The tool or the film 11 can be prepared by laser cutting or chemical etching, or post-coating photoetching.

Step S1.2: plating adhesive layers 130 on the to-be-plated positions 110 by vacuum plating, as shown in FIG. 1 (2).

Since the substrate 1 is made of a porous material, and the surface topography of the porous material has a large fluctuation, the heating layers formed by vacuum plating will fluctuate (discontinuously) along with the morphology of the porous material if the heating layers are directly plated on the porous material, so that a thinner portion of the heating layer is easy to be burned off to cause an open circuit, as a result the heating layer is damaged and cannot work. Therefore, the adhesive layers 130 are plated on the to-be-plated positions 110 before the heating layers are plated, to modify the surface of the substrate 1.

The adhesive layer 130 is made of an insulating hard thin film material with good hardness, strength, and thermal stability, and stable physical and chemical properties. The adhesive layer 130 is configured to strengthen the basement of the to-be-plated positions 110, improve the hardness and flatness of the surface of the basement of the to-be-plated positions 110, and enhance the adhesive force between the substrate 1 and the subsequent heating layer 120.

Alternatively, the material of the adhesion layer 130 may include one or more of Si, TiN, ZrN, TiC, TiO, Cr₂O₃, Al₂O₃, Fe₃C, Mn₂O₄, TiO₂, SiO₂, and the like.

Step S2: plating the heating layers 120 on the to-be-plated positions 110 by means of vacuum plating, according to the plurality of selected to-be-plated positions 110 on the surface of the substrate 1.

In this embodiment, the heating layers 120 are plated on the adhesive layers 130, as shown in of FIG. 1 (3).

The heating layer 120 is configured to generate heat when electrified to atomize a tobacco liquid. The heating layer 120 is made of an electrical resistance material with relatively high thermal efficiency, and the material of the heating layer 120 may include one or more of Ti, Ag, Cr, Ni, Fe, Al, an alloy material (such as stainless steel, nickel-chromium, iron-chromium-aluminum, etc.) of the foregoing metals (Ti, Ag, Cr, Ni, Fe, Al), carbon, graphite, and the like.

Referring to FIG. 1 (6), each heating layer 120 may include two electrode contacts 121 spaced apart from each other, and a heating track 122 connected between the two electrode contacts 121. The shape of heating track 122 may be a linear shape, a curved shape, a wavy shape, or the like. The two electrode contacts 121 may be located on one or two sides of the heating track 122.

Step S2.1: removing the shield used for shielding on the surface of the substrate 1. After removing is shown in (4) and (5) in FIG. 1.

According to the tool or the film 11 used for shielding, removing the tool accordingly, or uncovering the film or removing the film by solvent dissolution or high-temperature decomposition accordingly.

Step S3: cutting the substrate 1 into a plurality of separated base bodies 100 according to the positions of the plurality of heating layers 120, so that a plurality of atomizing assemblies can be prepared at one time. Each base body 100 and the heating layer 120 thereon form one atomizing assembly, as shown in (5) to (6) in FIG. 1.

The cutting can be realized by a dicing saw or a laser cutting machine. For accurate cutting, cutting alignment marks 12 can be provided on peripheries of the substrate 1 corresponding to the size of each atomizing assembly, and two cutting alignment marks 12 right opposite to each other are connected to form a cutting line during cutting. Each base body 100 formed by cutting is a polyhedron, such as a cuboid or the like.

The preparation method of this embodiment may further include the steps of:

Step S4: cleaning, drying and packaging the atomizing assembly.

The atomizing assembly prepared by the embodiment can be used in an electronic cigarette to atomize a liquid.

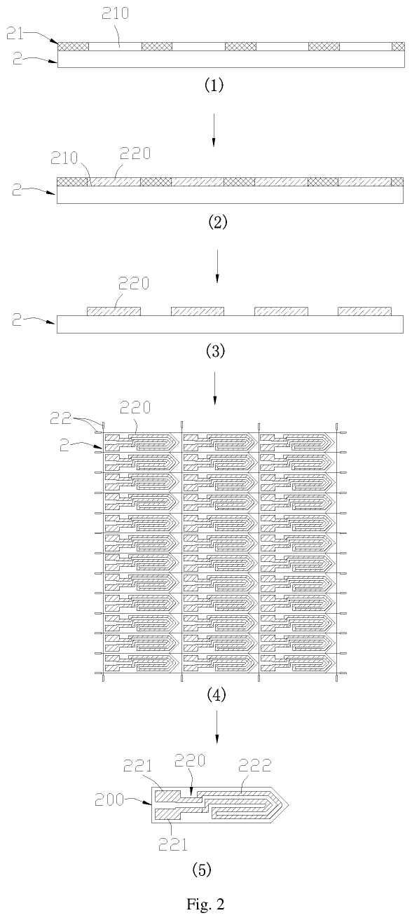

As shown in FIG. 2, a preparation method of an atomizing assembly of an electronic cigarette in a second embodiment of the present disclosure includes the following steps:

Step S1: providing a substrate 2.

In this embodiment, the substrate 2 is a thin sheet substrate with a smooth and flat surface. The substrate 2 is used to support the heating layer and has a low thermal conductivity, so as to prevent the non-heating portion from failing due to excessive temperature, and facilitate the control of the stability of the product. The thin sheet substrate can be made of a ceramic material with low thermal conductivity and high strength, such as zirconia, microcrystalline glass or the like, and may have a thickness of 0.1-0.5 mm.

A corresponding number of to-be-plated positions 210 is selected on an surface of the substrate 2 according to the size of the substrate 2 and the size and the quantity of the individual atomizing assembly to be prepared. A plurality of to-be-plated positions 210 are selected on a surface of the substrate 1 according to the surface of the substrate on which the heating layers in the atomizing assembly are located. In this embodiment, the plurality of to-be-plated positions 210 are spaced distributed, and may be arranged in a matrix (multiple rows and multiple columns).

Step S1.1: shielding the surface of the substrate 2 and exposing the to-be-plated positions 210 according to the plurality of selected to-be-plated positions 210 spaced arranged on the surface of the substrate 2.

As shown in FIG. 2 (1), a tool or a film 21 can be used for shielding, and the tool or the film 21 has a plurality of hollow portions; the tool or the film 21 is covered on the surface of the substrate 2 to shield portions of the surface of the substrate 2 other than where the plurality of to-be-plated positions 210 are located, and the hollow portions are configured to expose the to-be-plated positions 210. The tool or the film 21 can be prepared by laser cutting or chemical etching, or post-coating photoetching.

Step S2: plating the heating layers 220 on the to-be-plated positions 210 by vacuum plating according to the plurality of selected to-be-plated positions 210 on the surface of the substrate 2, as shown in FIG. 2 (2).

The heating layer 220 is configured to generate heat to bake and atomize a tobacco when being energized. The heating layer 220 is made of an electrical resistance material with relatively high thermal efficiency, and the material of the heating layer 220 may include one or more of Ti, Ag, Cr, Ni, Fe, Al, an alloy material (such as stainless steel, nickel-chromium, iron-chromium-aluminum, etc.) of the foregoing metals (Ti, Ag, Cr, Ni, Fe, Al), carbon, graphite, and the like.

Referring to FIG. 2 (5), each heating layer 220 may include two electrode contacts 221 spaced apart from each other, and a heating track 222 connected between the two electrode contacts 221. The heating track 222 may be linear, curved, wavy, or the like. The two electrode contacts 221 may be located on one or two sides of the heating track 222.

Step S2.1: removing the shield used for shielding on the surface of the substrate 2. After removing is shown in (3) and (4) of FIG. 2.

According to the tool or the film 21 used for shielding, removing the tool accordingly, or uncovering the film or removing the film by solvent dissolution or high-temperature decomposition accordingly.

Step S3: cutting the substrate 2 into a plurality of separated base bodies 200 according to the positions of the plurality of heating layers 220, so that a plurality of atomizing assemblies can be prepared at one time. Each base body 200 and the heating layer 220 thereon form one atomizing assembly, as shown in (3) to (4) in FIG. 2.

The cutting can be realized by a dicing saw and a laser cutting machine. For accurate cutting, cutting alignment marks 22 can be provided on peripheries of the substrate 2 corresponding to the size of each atomizing assembly, and two cutting alignment marks 22 right opposite to each other are connected to form a cutting line when cutting. Each base body 200 formed by cutting is a single thin sheet shaped or the like.

In the atomizing assembly prepared in this embodiment, one end of the base body 200 is tapered, so that the base body 200 is pentagonal in a whole shape.

The preparation method of this embodiment may further include the steps of:

Step S4: cleaning, drying and packaging the atomizing assembly.

The atomizing assembly prepared in the embodiment can be used in a baking type electronic cigarette.

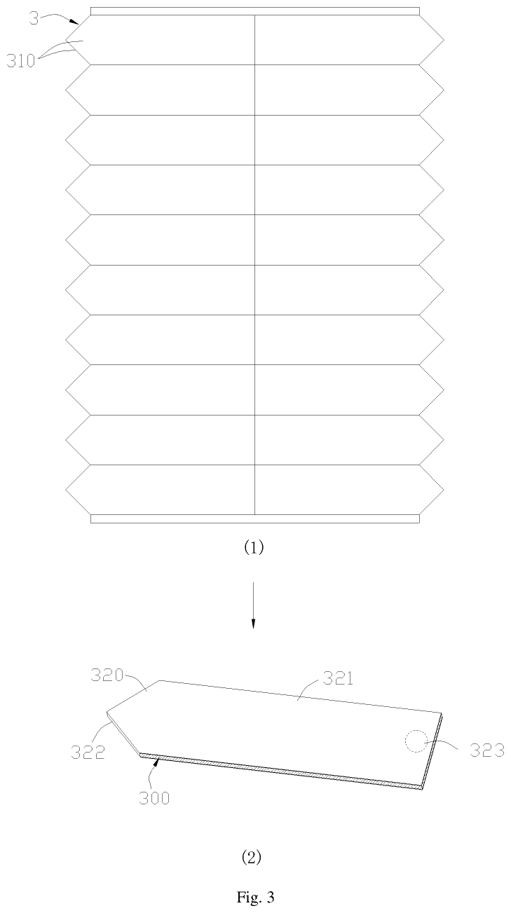

As shown in FIG. 3, a preparation method of an atomizing assembly of an electronic cigarette in a first embodiment of the present disclosure includes the following steps:

Step S1: providing a substrate 3.

In this embodiment, the substrate 3 is a thin sheet substrate and has a smooth and flat surface. The substrate 3 is used to support the heating layer and has a low thermal conductivity, so as to prevent the non-heating portion from failing due to excessive temperature, and facilitate the control of the stability of the product. The thin sheet substrate can be made of a ceramic material with low thermal conductivity and high strength, such as zirconia, microcrystalline glass or the like, and may have a thickness of 0.1-0.5 mm.

A corresponding number of to-be-plated positions 310 is selected on an surface of the substrate 3 according to the size of the substrate 3 and the size and the quantity of the individual atomizing assembly to be prepared.

A corresponding number of to-be-plated positions 310 is selected on an surface of the substrate 3 according to the size of the substrate 3 and the size and the quantity of the individual atomizing assembly to be prepared. In this embodiment, the plurality of to-be-plated positions 310 include two opposite surfaces of the substrate 3 and side surfaces of two opposite sides of the substrate 3.

In this embodiment, the step S1 further includes: processing the two opposite sides of the substrate 3 to form a predetermined shape corresponding to that of an end portion of the base body in the atomizing assembly, so as to expose the positions where the heating layers need to be plated, and the two opposite sides and the two opposite surfaces of the substrate 3 form the to-be-plated positions 310. The processing of the two opposite sides of the substrate 3 can be achieved by dicing with a dicing saw or a laser cutting machine.

Specifically, as shown in FIG. 3 (1), after processing, the two opposite sides of the substrate 3 are respectively in a shape of a broken line, or alternatively may be edges connected by multiple inverted V, inverted U or arc-shaped edges. Each inverted V, inverted U or arc-shaped edge is the end portion of the base body in one atomizing assembly correspondingly. Thus, the substrate 3 after processing may include two rows of base bodies connected with each other, each row of base bodies including a plurality of base bodies connected sequentially.

Step S2: plating the heating layers 320 on the to-be-plated positions 310 by vacuum plating according to the plurality of selected to-be-plated positions 310 on the surface of the substrate 3, as shown in FIG. 3 (2).

The heating layer 20 is configured to generate heat to bake and atomize a tobacco when being energized. The heating layer 20 is made of an electrical resistance material with relatively high thermal efficiency, and the material of the heating layer 20 may include one or more of Ti, Ag, Cr, Ni, Fe, Al, an alloy material (such as stainless steel, nickel-chromium, iron-chromium-aluminum, etc.) of the foregoing metals (Ti, Ag, Cr, Ni, Fe, Al), carbon, graphite, and the like.

Step S3: cutting the substrate 1 into a plurality of separated base bodies 300 according to the positions of the plurality of heating layers 320, and each base body 300 and the heating layer 320 thereon form one atomizing assembly.

The cutting can be realized by a dicing saw or a laser cutting machine. Each base body 300 formed by cutting is a single thin sheet shaped or the like.

In the atomizing assembly prepared in this embodiment, one end of the base body 300 is tapered, so that the base body 300 is pentagonal in a whole shape. The heating layers 320 of each atomizing assembly includes first heating layers 321 located on two opposite surfaces of the base body 300, and second heating layers 322 located on side surfaces of the tapered end portion of the base body 300. The heating layers 320 further includes two electrode contacts 323, and the electrode contacts 323 may be arranged on any positions of the heating layer 320, for example, on end portions (as shown by a dotted line in FIG. 3 (2)) of the first heating layers 321 on the two opposite surfaces of the base body 300 respectively.

The distribution area of the heating layers 320 on the base body 300 is large, so that the heating area is large, the tobacco can be heated more uniformly, and the atomization temperature can be controlled more accurately. Side surfaces of another end portion of the base body 300 and two opposite side surfaces in a length direction of the base body 300 are not provided with the heating layers.

Further, before step S3, a conductive layer (not shown) may be plated on the selected electrode contact 323. The specific operation is as follows: shielding the positions of the heating layers 320 other than where the electrode contact 323 is located, plating at least one conductor layer on the electrode contact 323 by vacuum plating, and then removing the shield. A tool or a film can be used for shielding. When removing the shield, the tool can be correspondingly removed, or the film can be uncovered or removed by solvent dissolution or high temperature decomposition. The material of the conductor layer may be a metal material such as gold, silver, or copper.

In addition, a protective layer (not shown) may be plated on the heating layer 320 other than where the electrode contact 323 is located. The specific operation is as follows: shielding the electrode contact, plating the protective layer on the unshielded position of the heating layer 320 by vacuum plating, and then removing the shield. A tool or a film can be used for shielding. When removing the shield, the tool can be correspondingly removed, or the film can be uncovered or removed by solvent dissolution or high temperature decomposition. The protective layer can be made of alumina, silicon carbide, silicon nitride, mullite or other material with good thermal conductivity and wear resistance.

The preparation method of this embodiment may further include the steps of:

Step S4: cleaning, drying and packaging the atomizing assembly.

The atomizing assembly prepared by the embodiment is suitable for a baking type electronic cigarette.

The above embodiments illustrate only the preferred embodiments of the present disclosure, of which the description is made in a specific and detailed way, but should not be thus construed as being limiting to the scope of the claims of present disclosure. Those having ordinary skill of the art may freely make combinations of the above-described technical features and make contemplate certain variations and improvements, without departing from the idea of the present disclosure, and all these are considered within the coverage scope of the claims of the present disclosure.

What is claimed is:

1. preparation method of an atomizing assembly of an electronic cigarette, wherein the preparation method comprises steps of:
S1, providing a substrate;
S2, plating a plurality of heating layers on a plurality of to-be-plated positions by vacuum plating according to the plurality of selected to-be-plated positions on a surface of the substrate; and
S3, cutting the substrate into a plurality of separated base bodies according to positions of the plurality of heating layers, wherein each base body and the heating layer thereon form one atomizing assembly.

2. The preparation method of the atomizing assembly of the electronic cigarette according to claim 1, wherein the plurality of to-be-plated positions are spaced arranged on the surface of the substrate; and wherein
before the step S2, the preparation method further comprises:
step S1.1, shielding the surface of the substrate and exposing the plurality of to-be-plated positions according to the plurality of selected to-be-plated positions which are spaced arranged on the surface of the substrate; and
before the step S3, the preparation method further comprises:
step S2.1, removing a shield used for shielding on the surface of the substrate.

3. The preparation method of the atomizing assembly of the electronic cigarette according to claim 2, wherein in the step S1, the substrate is a liquid conducting substrate, a pore diameter of the substrate is 5 μm to 200 μm, and a porosity of the substrate is 20% to 80%.

4. The preparation method of the atomizing assembly of the electronic cigarette according to claim 3, wherein before the step S2, the preparation method further comprises:
step S1.2, plating adhesive layers on the to-be-plated positions by vacuum plating;
wherein in the step S2, the heating layers are plated on the adhesive layers.

5. The preparation method of the atomizing assembly of the electronic cigarette according to claim 4, wherein a material of each adhesive layer comprises one or more of Si, TiN, ZrN, TiC, TiO, Cr₂O₃, Al₂O₃, Fe₃C, Mn₂O₄, TiO₂, SiO₂; and a material of each heating layer comprises one or more of Ti, Ag, Cr, Ni, Fe, Al and an alloy material thereof, carbon and graphite.

6. The preparation method of the atomizing assembly of the electronic cigarette according to claim 2, wherein in the step S1, the substrate is a thin sheet substrate with a smooth and flat surface.

7. The preparation method of the atomizing assembly of the electronic cigarette according to claim 2, wherein each heating layer comprises two spaced electrode contacts and a heating track connected between the two electrode contacts.

8. The preparation method of the atomizing assembly of the electronic cigarette according to claim 1, wherein in the step S1, the substrate is a thin sheet substrate with a smooth and flat surface; and
the step S1 further comprises: processing at least two opposite sides of the substrate according to a peripheral shape of each base body in the atomizing assembly; and
the plurality of to-be-plated positions comprise two opposite surfaces of the substrate and side surfaces of two opposite sides of the substrate.

9. The preparation method of the atomizing assembly of the electronic cigarette according to claim 1, wherein a material of each heating layer comprises one or more of Ti, Ag, Cr, Ni, Fe, Al and an alloy material thereof, carbon and graphite.

10. An atomizing assembly of an electronic cigarette, wherein the atomizing assembly is prepared by a preparation method comprising steps of:
S1, providing a substrate;
S2, plating a plurality of heating layers on a plurality of to-be-plated positions by vacuum plating according to the plurality of selected to-be-plated positions on a surface of the substrate; and
S3, cutting the substrate into a plurality of separated base bodies according to positions of the plurality of heating layers, wherein each base body and the heating layer thereon form one atomizing assembly.

11. The atomizing assembly of the electronic cigarette according to claim 10, wherein the plurality of to-be-plated positions are spaced arranged on the surface of the substrate; and
wherein
before the step S2, the preparation method further comprises:
step S1.1, shielding the surface of the substrate and exposing the plurality of to-be-plated positions according to the plurality of selected to-be-plated positions which are spaced arranged on the surface of the substrate; and
before the step S3, the preparation method further comprises:
step S2.1, removing a shield used for shielding on the surface of the substrate.

12. The atomizing assembly of the electronic cigarette according to claim 11, wherein in the step S1, the substrate is a liquid conducting substrate, a pore diameter of the substrate is 5 μm to 200 μm, and a porosity of the substrate is 20% to 80%.

13. The atomizing assembly of the electronic cigarette according to claim 12, wherein before the step S2, the preparation method further comprises:
step S1.2, plating adhesive layers on the to-be-plated positions by vacuum plating;
wherein in the step S2, the heating layers are plated on the adhesive layers.

14. The atomizing assembly of the electronic cigarette according to claim 13, wherein a material of each adhesive layer comprises one or more of Si, TiN, ZrN, TiC, TiO, Cr₂O₃, Al₂O₃, Fe₃C, Mn₂O₄, TiO₂, SiO₂; and a material of each heating layer comprises one or more of Ti, Ag, Cr, Ni, Fe, Al and an alloy material thereof, carbon and graphite.

15. The atomizing assembly of the electronic cigarette according to claim 11, wherein in the step S1, the substrate is a thin sheet substrate with a smooth and flat surface.

16. The atomizing assembly of the electronic cigarette according to claim 11, wherein each heating layer comprises two spaced electrode contacts and a heating track connected between the two electrode contacts.

17. The atomizing assembly of the electronic cigarette according to claim 10, wherein in the step S1, the substrate is a thin sheet substrate with a smooth and flat surface; and
the step S1 further comprises: processing at least two opposite sides of the substrate according to a peripheral shape of each base body in the atomizing assembly; and
the plurality of to-be-plated positions comprise two opposite surfaces of the substrate and side surfaces of two opposite sides of the substrate.

18. The atomizing assembly of the electronic cigarette according to claim 10, wherein a material of each heating layer comprises one or more of Ti, Ag, Cr, Ni, Fe, Al and an alloy material thereof, carbon and graphite.
